(19) United States
(12) Patent Application Publication
(10) Pub. No.: US 2004/0101060 A1
(43) Pub. Date: May 27, 2004

(54) Low power modulation

(75) Inventors: Thomas D. Simon, Southborough, MA (US); Rajeevan Amirtharajah, Providence, RI (US)

Correspondence Address: FISH & RICHARDSON, PC, 12390 EL CAMINO REAL, SAN DIEGO, CA, 92130-2081, US

(73) Assignee: Intel Corporation

(21) Appl. No.: 10/306,772

(22) Filed: Nov. 26, 2002

(51) Int. Cl. H04B 14/04; H04B 3/00; H04L 25/00

(52) U.S. Cl. 375/242; 375/257

(57) ABSTRACT

Performing low power modulation enabling a modulation scheme that conveys at least two bits of information using differential voltages having variable common mode voltage and using two voltage references and rejecting the common mode voltage.

### BACKGROUND

Digital electronics systems, such as computers, must move data among their component devices at increasing rates to take full advantage of the higher speeds at which these component devices operate. For example, a computer may include one or more processors that operate at frequencies of a gigahertz (GHz) or more. The data throughput of these processors outstrips the data delivery bandwidth of conventional systems by significant margins.

The digital bandwidth (BW) of a communication channel may be represented as:

BW=FₛNₛ.

Here, Fₛ is the frequency at which symbols are transmitted on a channel and Nₛ is the number of bits transmitted per symbol per clock cycle (“symbol density”). Channel refers to a basic unit of communication, for example a board trace in single ended signaling or the two complementary traces in differential signaling.

Conventional strategies for improving BW have focused on increasing one or both of the parameters Fₛ and Nₛ. However, these parameters cannot be increased without limit. For example, a bus trace behaves like a transmission line for frequencies at which the signal wavelength becomes comparable to the bus dimensions. In this high frequency regime, the electrical properties of the bus must be carefully managed. This is particularly true in standard multi-drop bus systems, which include three or more devices that are electrically connected to each bus trace through parallel stubs.

Practical BW limits are also created by interactions between the BW parameters, particularly at high frequencies. For example, the greater self-induced noise associated with high frequency signaling limits the reliability with which signals can be resolved. This limits the opportunity for employing higher symbol densities.

Modulation techniques have been employed in some digital systems to encode multiple bits in each transmitted symbol, thereby increasing Nₛ. The number of discernable symbols for any one modulation scheme grows exponentially in the number of bits per period encoded in that modulation scheme. Use of these techniques has been largely limited to point-to-point communication systems, particularly at high signaling frequencies. Because of their higher data densities, encoded symbols can be reliably resolved only in relatively low noise environments. Transmission line effects limit the use of modulation in high frequency communications, especially in multi-drop environments.

### DESCRIPTION OF DRAWINGS

FIG. 1 is a block diagram representing an electromagnetically-coupled bus system.

FIG. 2 is a schematic representation of a symbol that represents multiple bits of data.

FIGS. 3-6 are schematic representations of symbols that may be used in modulation.

FIGS. 7A-7D show representations of electromagnetic couplers.

FIGS. 8A and 8B are block diagrams of an interface.

FIG. 9 is a block diagram of a transceiver module.

FIGS. 10A-10D are circuit diagrams for various components of a transmitter.

FIGS. 11A-11E represent signals at various stages of data transmission of an electromagnetically-coupled bus system.

FIGS. 12A-12E are circuit diagrams for various components of a receiver module.

FIG. 13 is a block diagram of a calibration circuit.

### DESCRIPTION

A modulation scheme may be performed that conveys bits of information using different differential voltages. Generally, the number of voltage levels used to encode n bits of amplitude modulated (AM) data is 2ⁿ, e.g., two voltage levels to encode one bit, four voltage levels to encode two bits, etc. Varying differential voltages are typically produced with different voltage sources, while maintaining common mode voltages at some fixed level. However, allowing the common mode voltage to vary enables the generation of several differential voltages with fewer supply voltages. For example, generating differential voltages of one or two volts with fixed common mode means driving the differential pair to +½ and −½ volt or +1 and −1 volt. These four voltage references may be reduced to only two (the +1 and −1 volt) if the ±½ signal is replaced by one volt and ground on the two halves of the pair.

A discussion follows of an example scenario in which such modulation may be used.

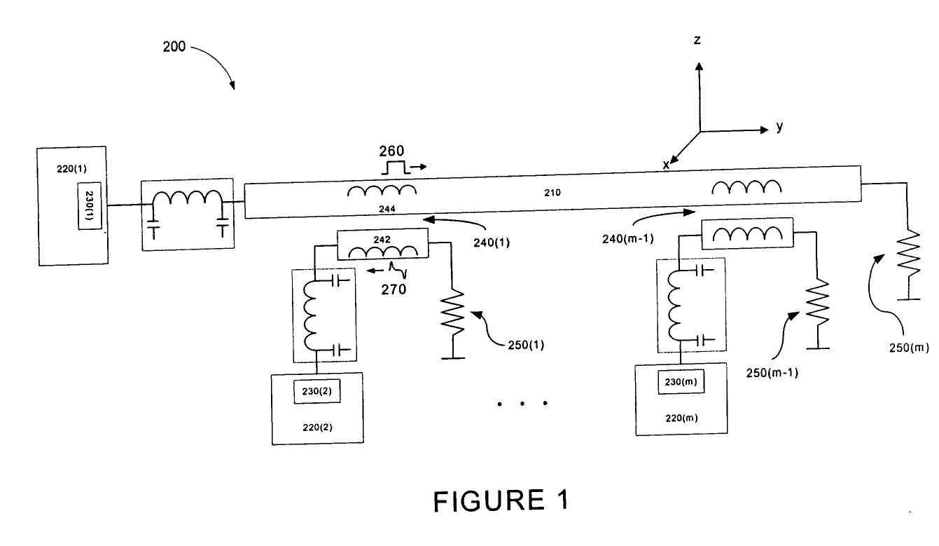

FIG. 1 is a schematic representation of an embodiment of a multi-drop bus system 200. Signals are transmitted electromagnetically between a device, e.g. device 220(2), and bus 210 through electromagnetic coupler 240(1). In the following discussion, electromagnetic coupling refers to the transfer of signal energy through the electric and magnetic fields associated with the signal. In general, a signal transferred across electromagnetic coupler 240 is differentiated. For example, a positive signal pulse 260 on bus side 244 of electromagnetic coupler 240 becomes a positive/negative-going pulse 270 on device side 242 of electromagnetic coupler 240. The modulation scheme(s) employed in system 200 are selected to accommodate the amplitude attenuation and signal differentiation associated with electromagnetic couplers 240 without degrading the reliability of the communication channel.

In an example embodiment, multi-drop bus system 200 includes a computer system and devices 220 correspond to various system components, such as processors, memory modules, system logic and the like.

In the following discussion, various time-domain modulation schemes are used for purposes of illustration. Other time-domain modulation schemes, such as shape modulation (varying the number of edges in a pulse), narrowband and wideband frequency-domain modulation schemes, such as frequency modulation, phase modulation, and spread spectrum, or combinations of both time and frequency-domain modulation schemes (a pulse superposed with a high frequency sinusoid), may also be used.

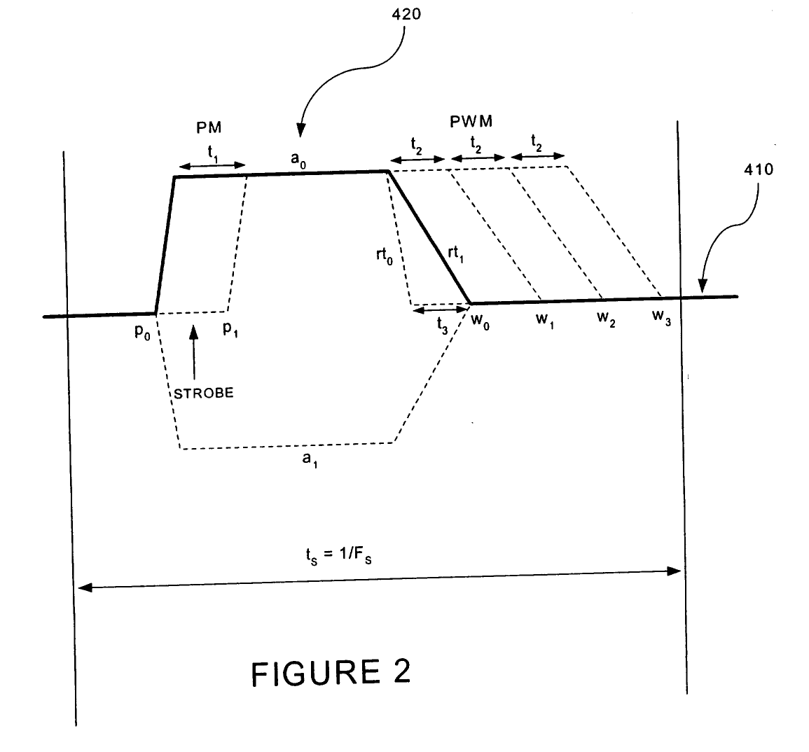

FIG. 2 is a schematic representation of a signal 410 that illustrates the interplay between Fs, Ns, and various modulation schemes that may be employed to encode multiple data bits into a symbol. Signal 410 includes a modulated symbol 420 transmitted in a symbol period (Fₛ⁻¹). For purposes of illustration, phase, pulse-width, rise-time, and amplitude modulation schemes are shown encoding five bits of data (Nₛ=5) in symbol 420. These modulation schemes may be used, as well as others, alone or in combination, to increase the bandwidth for a particular system. The modulation scheme(s) may be selected by considering the bit interval (see below), noise sources, and circuit limitations applicable to each modulation scheme under consideration, and the symbol period available for a given frequency.

In the following discussion, a “pulse” refers to a signal waveform having both a rising edge and a falling edge. For pulse-based signaling, information may be encoded, for example, in the edge positions, edge shapes (slopes), and signal amplitudes between edge pairs. Other signal waveforms, such as edge-based signaling and various types of amplitude, phase, or frequency-modulated periodic waveforms may be implemented as well. The following discussion focuses on modulation of pulse-based signaling schemes, but considerations similar to those discussed below for pulse-based signaling may be applied to other signal waveforms to select an appropriate modulation scheme.

For signal 410, the value of a first bit (0 or 1) is indicated by where (p₀ or p₁) the leading edge of symbol 420 occurs in the symbol period (phase modulation or PM). The values of second and third bits are indicated by which of four possible widths (w₀, w₁, w₂, W₃) the pulse has (pulse-width modulation or PWM). The value of a fourth bit is indicated by whether the falling edge has a large (rt₀) or small (rt₁) slope (rise-time modulation or RTM), and the value of a fifth bit is indicated by whether the pulse amplitude is positive or negative (a₀, a₁) (amplitude modulation or AM). Bold lines indicate an actual state of symbol 420, and dashed lines indicate other available states for the described encoding schemes. A strobe is indicated within the symbol period to provide a reference time with which the positions of the rising and falling edges may be compared. The number of bits encoded by each of the above-described modulation schemes is provided solely for illustration. In addition, RTM may be applied to the rising and/or falling edges of symbol 420, and AM may encode bits in the magnitude and/or sign of symbol 420.

PM, PWM, and RTM are examples of time-domain modulation schemes. Each time-domain modulation scheme encodes one or more bits in the time(s) at which one or more events, such as a rising edge or a rising edge followed by a falling edge, occur in the symbol period. That is, different bit states are represented by different event times or differences between event times in the symbol period. A bit interval associated with each time-domain modulation scheme represents a minimum amount of time necessary to reliably distinguish between the different bit states of the scheme. The modulation schemes selected for a particular system, and the number of bits represented by a selected modulation scheme is determined, in part, by the bit intervals of the candidate modulation schemes and the time available to accommodate them, i.e. the symbol period.

In FIG. 2, t₁ represents a minimum time required to distinguish between p₀ and p₁ for a phase modulation scheme. One bit interval of duration t₁ is allocated within the symbol period to allow the pulse edge to be reliably assigned to p₀ or p₁. The value of t₁ depends on noise and circuit limitations that can interfere with phase measurements. For example, if the strobe is provided by a clock pulse, clock jitter may make the strobe position (time) uncertain, which increases the minimum interval necessary to reliably distinguish between p₀ and p₁.

Similarly, one bit interval of duration t₃ is allocated within the symbol period to allow the two states (rt₀, rt₁) to be distinguished reliably. The size of t₃ is determined by noise and circuit limitations associated with rise time measurements. For example, rise times are differentiated by passing through coupler 240. Consequently, t₃ must be long enough to allow the measurement of a second derivative.

Three bit intervals of duration t₂ are allocated within the symbol period to allow the four states (w₀, w₁, w₂, W₃) to be reliably distinguished. The size of t₂ is determined by noise and circuit limitations associated with pulse width measurements. If pulse width is determined relative to a clock strobe, considerations regarding clock jitter may apply. If pulse width is determined relative to, e.g., the leading edge of a pulse, considerations such as supply voltage variations between the measurements of the leading and trailing edges may apply.

In general, the time needed to encode an n-bit value in a time-domain modulation scheme (i) that has a bit interval, t₁, is (2ⁿ−1)·t₁. If non-uniform bit intervals are preferred for noise or circuit reasons, the total time allotted to a modulation scheme is the sum of all of its bit intervals. When multiple time-domain modulation schemes are employed, the symbol period should be long enough to accommodate Σ(2ⁿ⁽¹⁾−1)·t₁, plus any additional timing margins. Here, the summation is over all time-domain modulation schemes used. In the above example, the symbol period should accommodate t₁+t₃+3t₂, plus any other margins or timings. These may include minimum pulse widths indicated by channel bandwidth, residual noise, and the like.

Using multiple encoding schemes reduces the constraints on the symbol time. For example, encoding five bits using pulse width modulation alone requires at least 31·t₂. If t₂ is large enough, the use of the single encoding scheme might require a larger symbol period (lower symbol frequency) than would otherwise be necessary.

A minimum resolution time can also be associated with amplitude modulation. Unlike the time domain modulation schemes, amplitude modulation encodes data in pulse properties that are substantially orthogonal to edge positions. Consequently, it need not add directly to the total bit intervals accommodated by the symbol period. For example, amplitude modulation uses the sign or magnitude of a voltage level to encode data.

The different modulation schemes are not completely orthogonal, however. In the above example, two amplitude states encode one bit, and the minimum time associated with this interval may be determined, for example, by the response time of a detector circuit to a voltage having amplitude, A. The pulse width should be at least long enough for the sign of A to be determined. Similarly, a symbol characterized by rise-time state rt₁ and width state W₃ may interfere with a next symbol characterized by phase state p₀. Thus, noise and circuit limitations (partly summarized in the bit intervals), the relative independence of modulation schemes, and various other factors are considered when selecting modulation scheme(s).

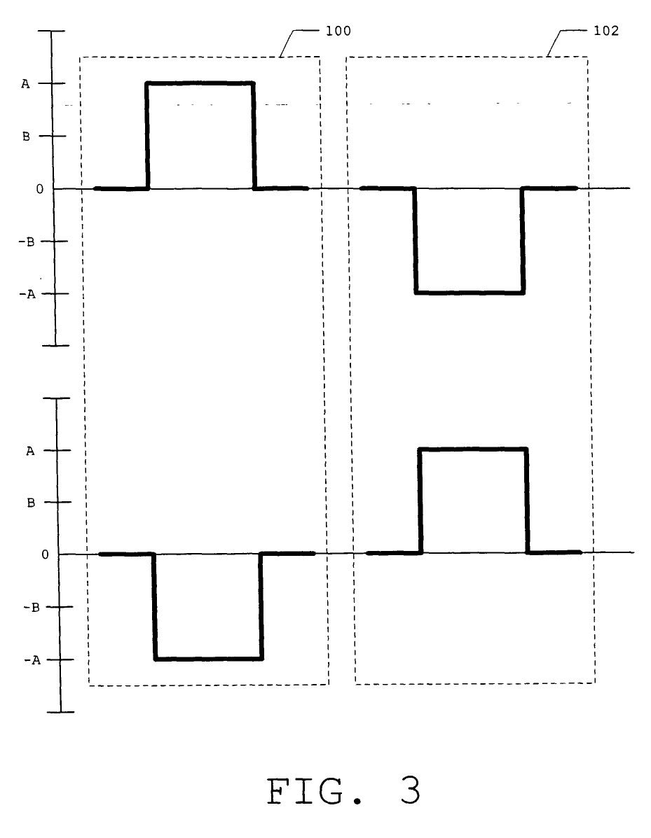

FIG. 3 shows a first differential pulse symbol 100 and a second differential pulse symbol 102 as example symbols (as pairs of waveforms) that may be used to encode one bit of amplitude modulation. Given supply voltages of A and −A, the first symbol 100 may have a differential voltage level of 2A. Similarly, the second symbol 102 may have a differential voltage level of −2A. For these symbols, the common mode voltage equals zero.

FIG. 4 shows a third differential pulse symbol 104 and a fourth differential pulse symbol 106 as example symbols that may be used to encode one bit of amplitude modulation. The third symbol 104 has a differential voltage level of 2B, where B equals half of A in this example, while the fourth symbol 106 has a differential voltage level of −2B. The common mode voltage for the third symbol 104 and the fourth symbol 106 equals zero.

Symbols in FIG. 3 (e.g., 100 and 102) may be used in conjunction with symbols in FIG. 4 (e.g., 104 and 106) to encode two bits of amplitude modulation. The ratio of two between the two height sets in this example (voltage levels of +A in FIG. 3 and voltage levels of ±B in FIG. 4) can optimally allocate the available voltage range in terms of signal to noise ratios. Other ratios may be used. If the A voltage levels result from a main supply voltage available to circuitry performing the amplitude modulation, the B voltage levels may be produced from the same source or they may require a supply voltage of B from an additional voltage supply, on-chip generation, or otherwise produced or made available to the circuitry.

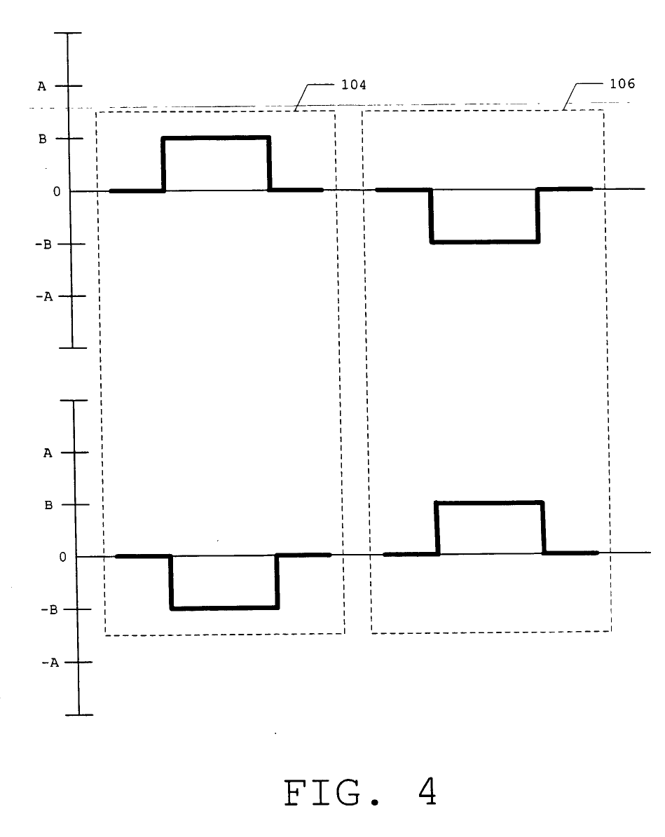

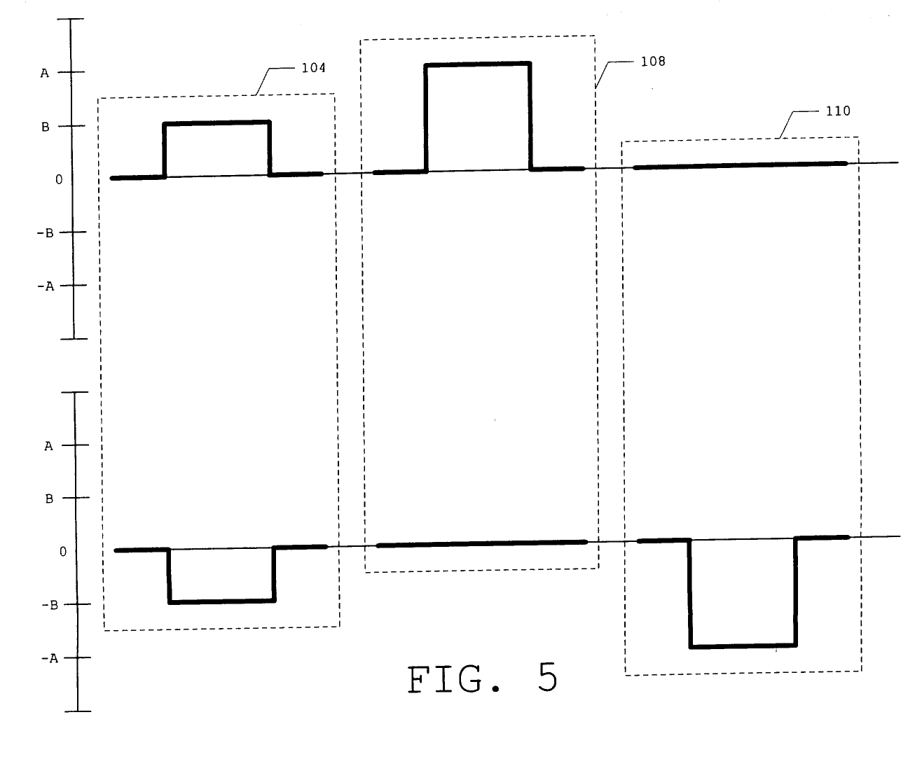

FIG. 5 shows a fifth differential pulse symbol 108 and a sixth differential pulse symbol 110 as example symbols that may be used as equivalent differential voltage substitutes for symbol 104 (see also FIG. 4) if A equals 2B, though with varying common mode voltages.

The voltage pairs in FIG. 5 demonstrate that symbols used to encode data in modulation need not all have equal and opposite voltage levels. For example, one voltage pair, symbol 104, has equal and opposite voltage levels, B and −B, having a zero common mode voltage and a differential voltage of A. Other equivalent voltage pairs, symbols 108 and 110, have a non-zero common mode voltage (B and −B respectively) and a differential voltage of A.

FIG. 6 shows a seventh differential pulse symbol 112 and a eighth differential pulse symbol 114 as example symbols that may be used to substitute for symbol 106 (see also FIG. 4) similar to the substitution described for FIG. 5.

FIGS. 5 and 6 show symbols having non-zero common mode voltages that may be used in conjunction to encode one bit of amplitude modulation or with another pair of symbols to encode two bits of amplitude modulation. The differential voltages of the symbols in FIGS. 5 and 6 equal A (2B).

The voltage levels in FIGS. 5 and 6 may be provided or generated by voltage supplies of A and −A. Thus, two voltage supplies may be used in encoding two bits of amplitude modulation by using, e.g., the first and second symbols 100 and 102 of FIG. 3 by sending one conductor to A and one to −A, the fifth or sixth symbols 108 and 110 of FIG. 5 by sending one conductor to A and the other to zero, and the seventh or eighth symbols 112 and 114 similarly.

Pulse signaling is used as an example in FIGS. 3-6. Other types of signaling such as edge and level signaling may be used in amplitude modulation and in other types of modulation.

When a voltage pair has a non-zero and/or varying common mode voltage, a common mode rejection technique may be used to avoid confusing a receiver of the voltage levels, e.g., a differential receiver, a comparator, an amplifier, etc. The system performing the modulation may use any common mode rejection technique in any way appropriate for and workable in the system.

When a voltage pair has non-zero common mode voltage, the symbols may have imbalanced current requirements. For example, symbols 108 and 114 in FIGS. 5 and 6, respectively, draw current from a positive supply voltage A but do not sink current to ground or −A at the same time. Current balancing may be used across multiple signaling pairs to alleviate simultaneous switching supply noises.

In an example of performing amplitude modulation using non-zero common mode symbols in a bus environment, overall current requirements may be balanced if the representations of individual outputs are chosen to offset each other. For example, if all thirty-two outputs of a thirty-two wide bus need to transmit the equivalent symbols 108 or 110 of FIG. 5 in the same cycle, balanced current usage may be achieved by choosing sixteen outputs to drive symbols 108 and sixteen to drive 110. This balancing may be done by alternating the current usage of all outputs transmitting symbols in FIGS. 5 and 6. This current balancing does not require extra bits as with single ended signaling, no extra decoding logic at the receiver (if the common mode rejection of the receiver automatically performs the decoding), and minimal logic at the transmitter (compared to single ended balancing techniques) to perform the alternations. If multiple modulations are performed (e.g., two or more of amplitude modulation, phase modulation, pulse width modulation, rise-time modulation, etc.), current balancing may need to be separately performed in each category of phase, width, and rise-time choices or the current balancing may only be on average at the scale of a clock period but not instantaneously at the scale of phase shifts, etc.

In an example using the multi-drop bus system of FIG. 1, electromagnetic couplers 240 have geometries that make their coupling coefficients less sensitive to the relative positioning of device side component 242 and bus side component 244. These geometries allow balanced couplers 240 to maintain their coupling coefficients in a selected range, despite variations in the horizontal or vertical separations of device and bus side components 242 and 244, respectively. Furthermore, with stabilized coupling coefficients, the translation of common mode voltage to differential noise may be reduced and the negative impact (if any) of differential noise on differential signaling in circuits that cannot reject non-zero common mode voltage may be reduced.

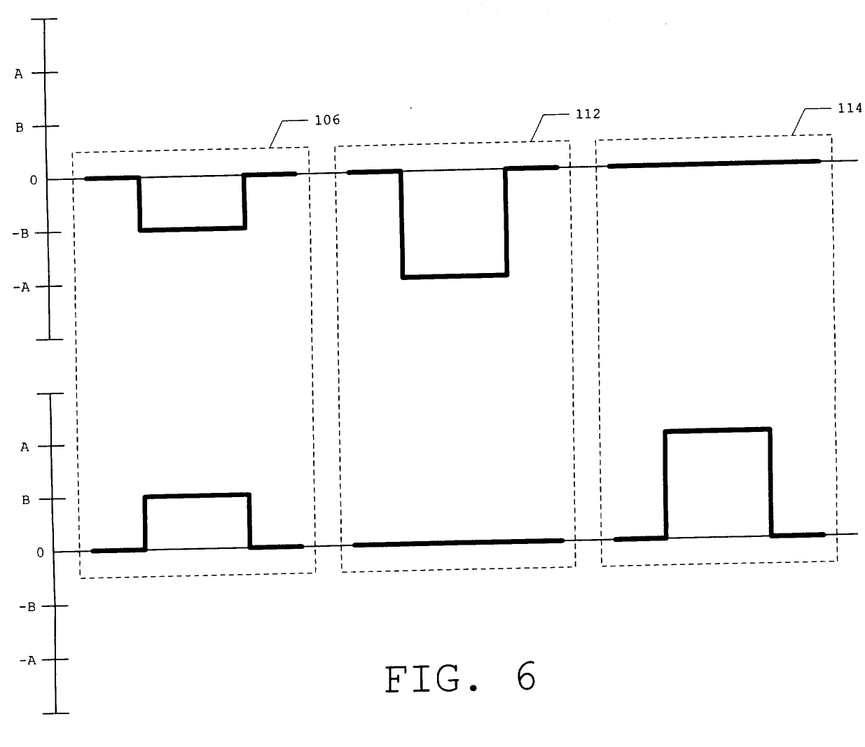

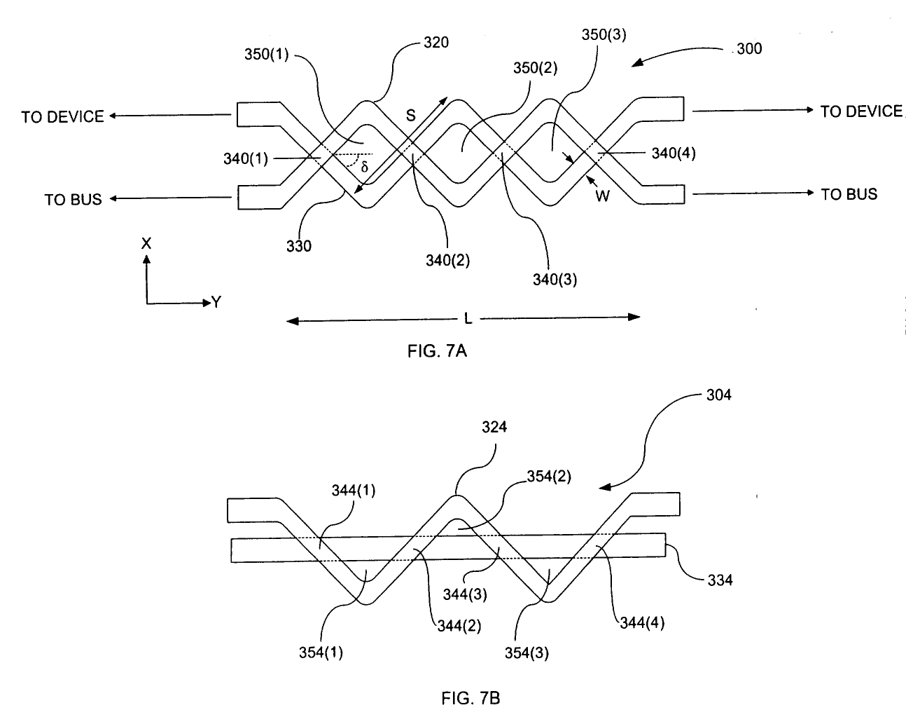

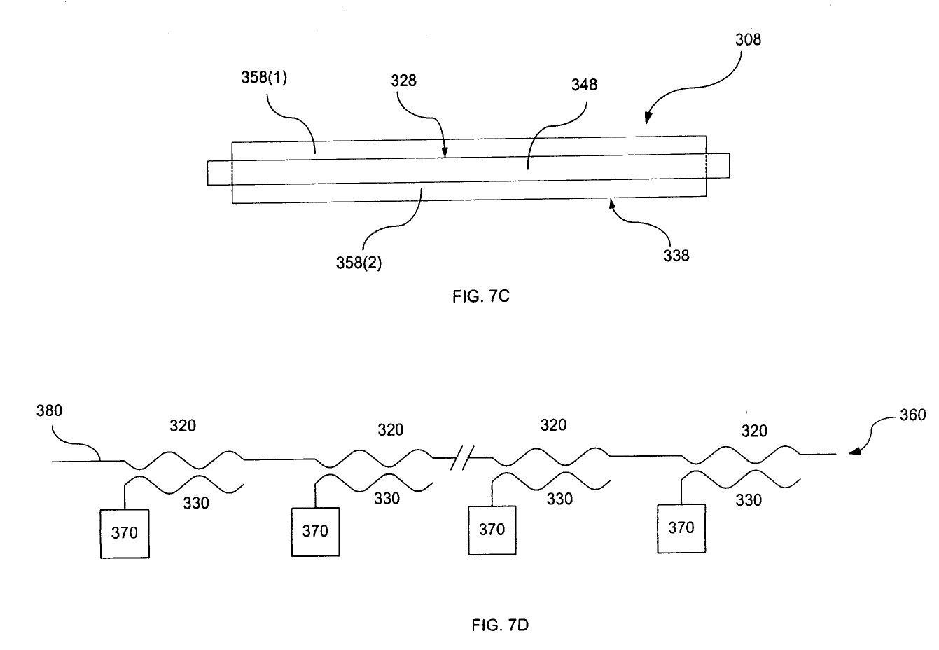

FIG. 7A represents one example 300 of balanced electromagnetic coupler 240 having a geometry that provides relatively stable coupling between device 220 and bus 210. Coupler 300 is viewed looking in the negative z direction, relative to the coordinate system indicated in FIG. 1 (a portion of which is reproduced in FIG. 7A). For this orientation, a bus side component 320 appears above a device side component 330 of electromagnetic coupler 300. The geometries of bus and device side components 320, 330 allow the amount of energy transferred through coupler 300 to be relatively insensitive to the relative alignment of bus and device side components 320, 330.

For coupler 300, bus side component 320 undulates about a longitudinal direction defined by its end-points (along the y-axis) to form a zig-zag pattern. Bus side component 320 includes four excursions from the longitudinal direction that alternate in the positive and negative x direction. The disclosed number, size, and angles of the excursions from the longitudinal direction are provided to illustrate the geometry generally. Their values may be varied to meet the constraints of a particular embodiment. Device side component 330 has a similar zig-zag pattern that is complementary to that of bus side component 320.

The repeated crossings form parallel plate regions 340(1)-340(4) (generically, “parallel plate regions 340”) and fringe regions 350(1)-350(3) (generically, “fringe regions 350”) for coupler 300. Parallel plate and fringe regions 340 and 350, respectively, provide different contributions to the coupling coefficient of coupler 300, which mitigate the effects of variations in the relative alignment of components 320 and 330. For example, the sizes of plate regions 340 do not vary significantly if components 320 and 330 are shifted slightly from their reference positions in the x, y plane, and the sizes of fringe regions 350 vary so that changes in adjacent regions approximately offset each other when components 320 and 330 are shifted from their reference positions in the x, y plane. In an example of coupler 300 in which S is 0.125 cm, δ=35°, and W is 5 mils, K_{C} varies by only ±2% as components 320 and 330 are shifted by ±8 mils in the x and/or y directions from their nominally aligned positions.

The effects of variations in the vertical separations between components 320 and 330 are also mitigated in coupler 300. Coupling in parallel plate regions 340 varies inversely with separation (z), while variations in fringe regions 350 vary more slowly with separation. The net effect is a reduced sensitivity to variations in z for coupler 300. With this choice of coupler geometry, a ±30% change in coupler separation (z) results in the capacitive coupling coefficient varying by less than ±15%. This compares favorably with parallel plate based coupler geometries, which show a +40/+30% variation over the same range of conductor separations.

In the example of coupler 300, components 320 and 330 have rounded corners to provide a relatively uniform impedance environment for signals transmitted along either component. For similar reasons, components 320 and 330 have relatively uniform cross sections. In sum, coupler 300 provides robust signal transmission between device 220 and bus 210, without introducing significant impedance changes in either environment.

FIG. 7B represents another example 304 of balanced electromagnetic coupler 240. In this example, one component 324 retains the undulating or zig-zag geometry similar to that described above for component 320 while a second component 334 has a substantially straight geometry. Component 334 may form either the bus side or device side of coupler 304, while component 324 forms the opposite side. Coupler 304 includes both parallel plate regions 344 and fringe regions 354, although the latter is smaller than fringe region 350 in coupler 300. Consequently, coupler 304 may be more sensitive to variations in the relative positions of components 324 and 334 than coupler 300.

FIG. 7C represents yet another example 308 of balanced electromagnetic coupler 240. For this embodiment, one component 328 is narrower than a second component 338 to provide both parallel plate region 348 and fringe regions 358.

FIG. 7D illustrates a portion of a multi-drop bus system 360 that incorporates coupler 300 A bus trace 380 includes multiple bus side components 320 at spaced intervals along its length. Corresponding devices 370 are coupled to bus trace 380 through their associated device side components 330. Components 320, 330 are shown rotated to indicate their geometry. Embodiments of coupler 300 may include selected dielectric materials between components 320, 330 to facilitate positioning or adjust the coupling coefficient.

Parallel plate couplers are also susceptible to noise problems if they are implemented in a differential signaling scheme where complementary signals are driven on pairs of bus traces. For these systems, a pair of couplers transfers the complementary signals to a differential receiver in a device. The sensitivity of parallel plate couplers to variations in the positions of their components increases the likelihood that coupler pairs have mismatched coupling coefficients. This results in differential noise, which undermines the benefits of differential signaling. Further, unless the couplers are spaced sufficiently far apart (increasing the circuit board area needed to support them), the complementary signals can cross couple, with a resulting loss in signal to noise ratio.

The effects of such differential noise may be reduced by moving the coupler pairs together, e.g., keep both sides of the pair closely matched. For example, the geometries of electromagnetic couplers 240 (see FIG. 1) may be chosen to maintain these selected coupling coefficients against variations in the relative positioning of bus and device side coupling components, 242 and 244, respectively.

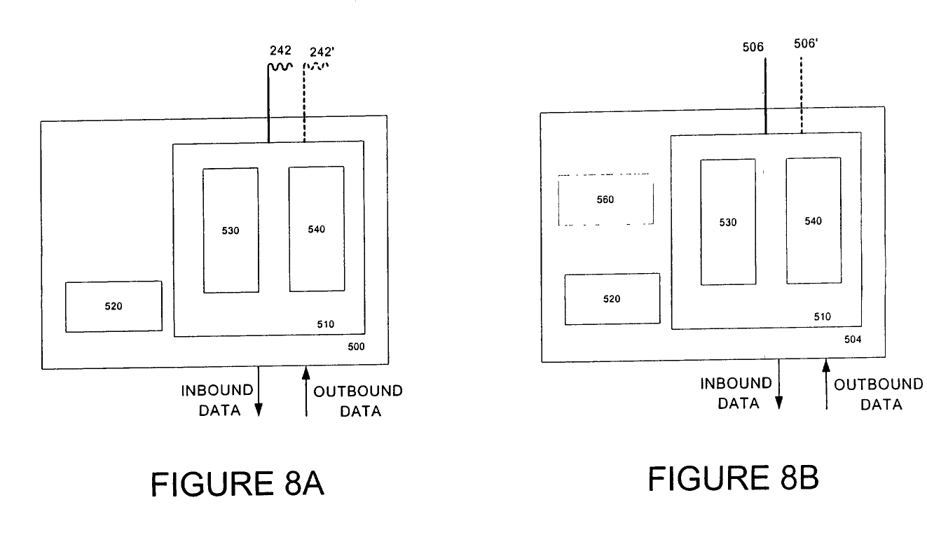

FIG. 8A is a block diagram of an embodiment 500 of interface 230 suitable for processing multi-bit symbols for devices 220(2)-220(m). For example, interface 500 may be used to encode outbound bits from, e.g., device 220(2) into a corresponding symbol for transmission on bus 210, and to decode a symbol received on bus 210 into inbound bits for use by device 220(2).

The example interface 230 includes a transceiver 510 and a calibration circuit 520. Also shown in FIG. 8A is device side component 242 of electromagnetic coupler 240 to provide a transferred waveform to transceiver 510. For example, the transferred waveform may be the differentiated waveform generated by transmitting pulse 420 across electromagnetic coupler 240. A device side component 242 is provided for each channel, e.g. bus trace, on which interface 230 communicates. A second device side component 242′ is indicated for the case in which differential signaling is employed.

Transceiver 510 includes a receiver 530 and a transmitter 540. Receiver 530 recovers the bits encoded in the transferred waveform on device side component 242 of electromagnetic coupler 240 and provides the recovered bits to the device associated with interface 230. Embodiments of receiver 530 may include an amplifier to offset the attenuation of signal energy on transmission across electromagnetic coupler 240. Transmitter 540 encodes data bits provided by the associated device into a symbol and drives the symbol onto device side 242 of electromagnetic coupler 240.

Calibration circuit 520 manages various parameters that may affect the performance of transceiver 510. For one embodiment of interface 230, calibration circuit 520 may be used to adjust termination resistances, amplifier gains, or signal delays in transceiver 510, responsive to variations in process, temperature, voltage, and the like.

FIG. 8B is a block diagram of an embodiment 504 of interface 230 that is suitable for processing encoded symbols for a device that is directly connected to the communication channel. For example, in system 200 (FIG. 1), device 220(1) may represent the system logic or chipset of a computer system that is directly connected to a memory bus (210), and devices 220(2)-220(m) may represent memory modules for the computer system. Accordingly, a DC connection 506 is provided for each channel or trace on which interface 504 communicates. A second DC connection 506′ (per channel) is indicated for the case in which differential signaling is employed. Interface 504 may include a clock synchronization circuit 560 to account for timing differences in signals forwarded from different devices 220(2)-220(m) and a local clock.

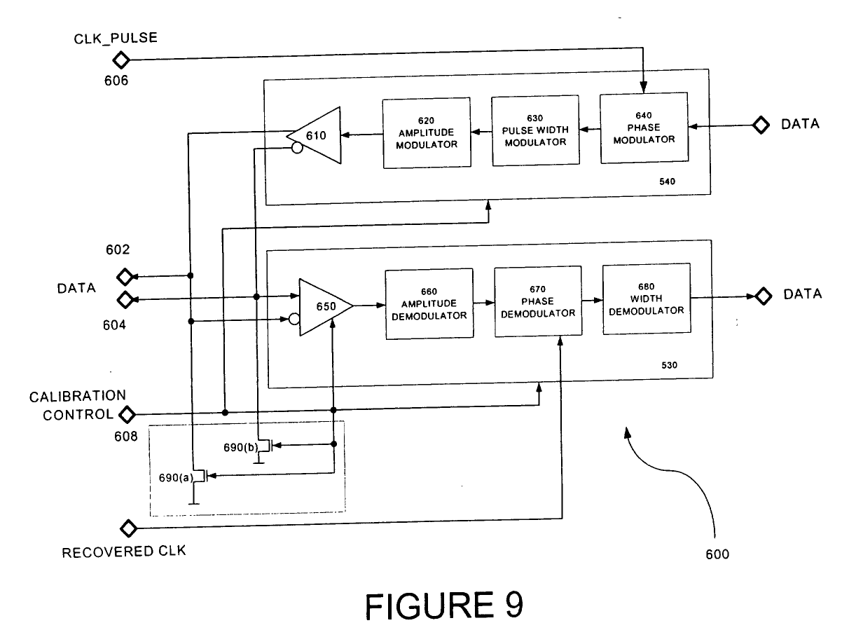

FIG. 9 is a block diagram representing an embodiment 600 of transceiver 510 that is suitable for handling waveforms in which data bits are encoded using phase, pulse-width and/or amplitude modulation, and the strobe is provided by a clock signal. Transceiver 600 supports differential signaling, as indicated by data pads 602, 604, and it receives calibration control signals from, e.g., calibration circuit 520, via control signals 608.

In the example transceiver 510, transmitter 540 includes a phase modulator 640, a pulse-width modulator 630, an amplitude modulator 620 and an output buffer 610. Output buffer 610 provides inverted and non-inverted outputs to pads 602 and 604, respectively, to support differential signaling. A clock signal is provided to phase modulator 640 to synchronize transceiver 510 with a system clock. The disclosed configuration of modulators 620, 630, and 640 is provided only for purposes of illustration. The corresponding modulation schemes may be applied in a different order or two or more schemes may be applied in parallel.

The receiver 530 in this example includes an amplifier 650, an amplitude demodulator 660, a phase demodulator 670, and a pulse-width demodulator 680. The order of demodulators 660, 670, and 680 may be different than illustrated. For example, various demodulators may operate on a signal in parallel or in an order different from that indicated.

Devices 690(a) and 690(b) (generically, “device 690”) act as on-chip termination impedances, which may be active while interface 230 is receiving. The effectiveness of device 690 in the face of, e.g., process, temperature, and voltage variations may be aided by calibration circuit 520. For transceiver 600, device 690 is shown as an N device, but the desired functionality may be provided by multiple N and/or P devices in series or in parallel. The control provided by calibration circuit 520 may be in digital or analog form, and may be conditioned with an output enable.

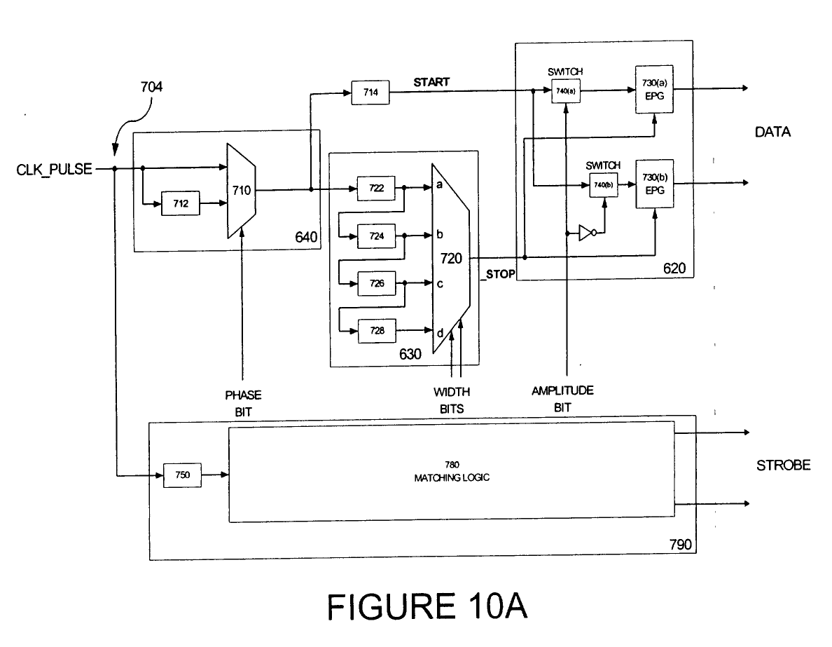

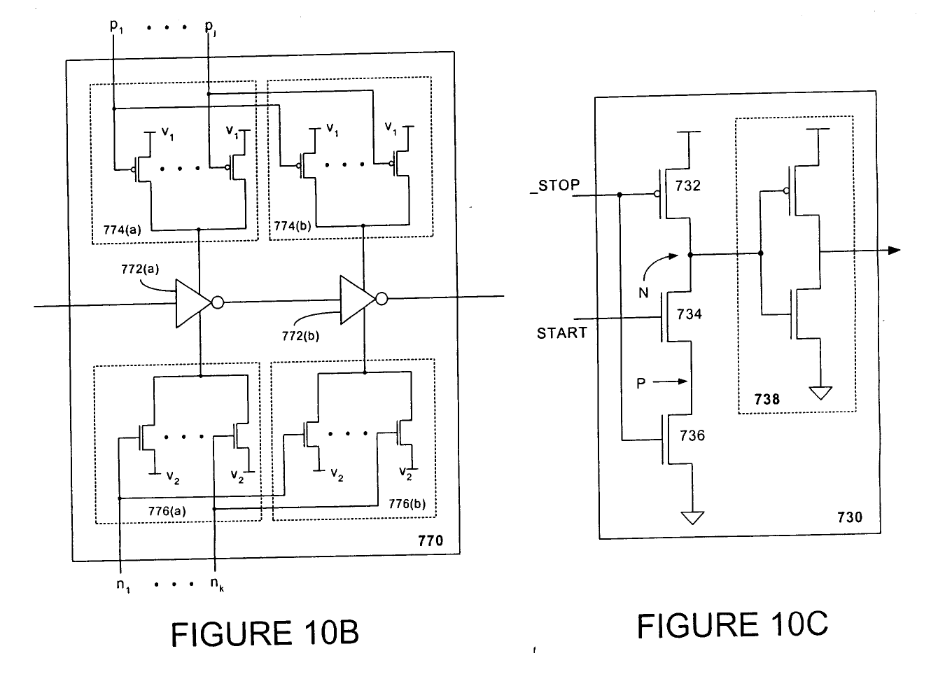

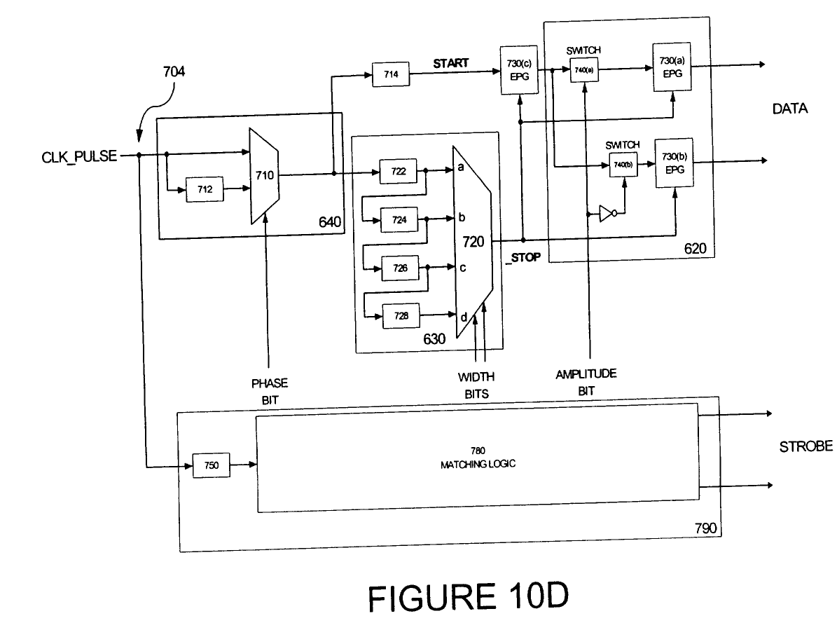

FIG. 10A is a circuit diagram of one embodiment of transmitter 540 and its component modulators 620, 630, 640. Also shown is a strobe transmitter 790 suitable for generating a strobe signal, which may be transmitted via bus 210. For the system 200, two separate strobes may be provided. One strobe may be provided for communications from device 220(1) to devices 220(2) through 220(m), and another strobe may be provided for communications from devices 220(2) through 220(m) back to device 220(1).

The example transmitter 540 modulates a clock signal (CLK_PULSE) to encode four outbound bits per symbol period. One bit is encoded in the symbol's phase (phase bit), two bits are encoded in the symbol's width (width bits) and one bit is encoded in the symbol's amplitude (amplitude bit). Transmitter 540 may be used to generate a differential symbol pulse per symbol period, and strobe transmitter 790 may be used to generate a differential clock pulse per symbol period.

Phase modulator 640 includes a MUX 710 and delay module (DM) 712. MUX 710 receives a delayed version of CLK_PULSE via DM 712 and an undelayed version of CLK_PULSE from input 704. The control input of MUX 710 transmits a delayed or undelayed first edge of CLK_PULSE responsive to the value of the phase bit. In general, a phase modulator 640 that encodes p phase bits may select one of 2p versions of CLK_PULSE subject to different delays. In this example, the output of phase modulator 640 indicates the leading edge of symbol 420 and serves as a timing reference for generation of the trailing edge by width modulator 630. A delay-matching block (DMB) 714 is provided to offset circuit delays in width modulator 630 (such as the delay of MUX 720) which might detrimentally affect the width of symbol 420. The output of DMB 714 is a start signal (START), which is provided to amplitude modulator 620 for additional processing.

Width modulator 630 includes DMs 722, 724, 726, 728, and MUX 720 to generate a second edge that is delayed relative to the first edge by an amount indicated by the width bits. The delayed second edge forms a stop signal (_STOP) that is input to amplitude modulator 620 for additional processing. In the example transmitter 540, two bits applied to the control input of MUX 720 select one of four different delays for the second edge, which is provided at the output of MUX 720. Inputs a, b, c, and d of MUX 720 sample the input signal, i.e. the first edge, following its passage through DMs 722, 724, 726, and 728, respectively. If the width bits indicate input c, for example, the second edge output by MUX 720 is delayed by DM 722+DM 724+DM 726 relative to the first edge.

Amplitude modulator 620 uses START and _STOP to generate a symbol pulse having a first edge, a width, and a polarity indicated by the phase, width, and amplitude bits, respectively, provided to transmitter 540 for a given symbol period. Amplitude modulator 620 includes switches 740(a) and 740(b) which route START to edge-to-pulse generators (EPG) 730(a) and 730(b), respectively, depending on the state of the amplitude bit. Switches 740 may be AND gates, for example. _STOP is provided to second inputs of EPGs 730(a) and 730(b) (generically, EPG 730). On receipt of START, EPG 730 initiates a symbol pulse, which it terminates on receipt of _STOP. Depending on which EPG 730 is activated, a positive or a negative going pulse is provided to the output of transmitter 540 via differential output buffer 610.

Strobe transmitter 790 includes DM 750 and matching logic block 780. DM 750 delays CLK_PULSE to provide a strobe signal that is suitable for resolving the data phase choices p₀ and p₁ of symbol 420. In the example strobe transmitter 790, DM 750 positions the strobe evenly between the phase bit states represented by p₀ and p₁ (FIG. 2). The strobe is used by, e.g., receiver 530 to demodulate phase by determining if the leading edge of data arrives before or after the strobe. DM 750 of strobe transmitter 790 thus corresponds to phase modulator 640 of data transmitter 540. Matching logic block 780 duplicates the remaining circuits of transmitter 540 to keep the timing of the strobe consistent with the data, after DM 750 has fixed the relative positioning.

In general, DM 750 and matching logic block 780 duplicate for the strobe the operations of transmitter 540 on data signals at the level of physical layout. Consequently, this delay matching is robust to variations in process, temperature, voltage, etc. In addition, the remainder of the communication channel from the output of transmitter 540, through board traces, electromagnetic coupler 240, board traces on the other side of coupler 240, and to the inputs of receiver 530 at the receiving device, may be matched in delays between data and strobe in order to keep the chosen relative timing. However, the matching of delays is an example described for illustrative purposes. For example, if the circuits and remainder of the channel do not maintain matched data to strobe delays, receivers may calibrate for the relative timing of the strobe or even compensate for the absence of a strobe by recovering the timing from appropriately encoded data.

FIG. 10B is a schematic diagram of one embodiment of a programmable delay module (DM) 770. For example, one or more DMs 770 may be used for any of DMs 712, 722, 724, 726, 728, and 750 in the example transmitter 540 to introduce programmable delays in START and _STOP. DM 770 includes inverters 772(a) and 772(b) that are coupled to reference voltages V₁ and V₂ through first and second transistor sets 774(a), 774(b) and 776(a), 776(b), respectively. Reference voltages V₁ and V₂ may be the digital supply voltages in some embodiments. Programming signals, p₁-pⱼ and n₁-nₖ, applied to transistor sets 774(a), 774(b) and 776(a), 776(b), respectively, alter the conductances seen by inverters 772(a) and 722(b) and, consequently, their speeds. As discussed below in greater detail, calibration circuit 520 may be used to select programming signals, p₁-pⱼ and n₁-nₖ, for inverters 772(a) and 772(b).

FIG. 10C is a schematic diagram of one embodiment of EPG 730. The example EPG 730 includes transistors 732, 734, and 736 and inverter 738. The gate of N-type transistor 734 is driven by START. A positive-going edge on START indicates the beginning of a symbol pulse. The gates of P and N-type transistors 732 and 736, respectively, are driven by _STOP, which, for EPG 730(a) and 730(b) in FIG. 10A, is a delayed, inverted copy of START. A negative-going edge on_STOP indicates the end of a symbol pulse. When _STOP is high, transistor 732 is off and transistor 736 is on. A positive-going edge on START turns on transistor 734, pulling node N low and generating a leading edge for a symbol pulse at the output of EPG 730. A subsequent negative-going edge on _STOP, turns off transistor 736 and turns on transistor 732, pulling node N high and terminating the symbol pulse.

For a given symbol pulse, START may be deasserted (negative-going edge) before or after the corresponding _STOP is asserted. For example, the example transmitter 540 is timed with CLK_PULSE, and higher symbol densities may be obtained by employing narrow CLK_PULSEs. The widths of START and _STOP are thus a function of the CLK PULSE width, while the separation between START and STOP is a function of the width bits. The different possible relative arrivals of the end of START and beginning of _STOP may adversely affect the modulation of symbol 420 by the width bits. Specifically, transistor 734 may be on or off when a negative-going edge of _STOP terminates the symbol pulse. Node N may thus either be exposed to the parasitic capacitances at node P through transistor 734, or not. This variability may affect the delay of the trailing symbol edge through EPG 730 in an unintended way.

FIG. 10D is a schematic diagram of an alternative embodiment of transmitter 540 that includes an additional EPG 730(c). EPG 730(c) reshapes START to ensure a consistent timing which avoids the variability described above. Namely, the modified START is widened so that it always ends after _STOP begins. This is done by generating a new START whose beginning is indicated by the original START but whose end is indicated by the beginning of _STOP, instead of the width of CLK_PULSE. Note also that, in the alternative embodiment shown in FIG. 10D, the sum of the delays through delay matching block 714 and EPG 730(c) must match the unintended delays in width modulator 630.

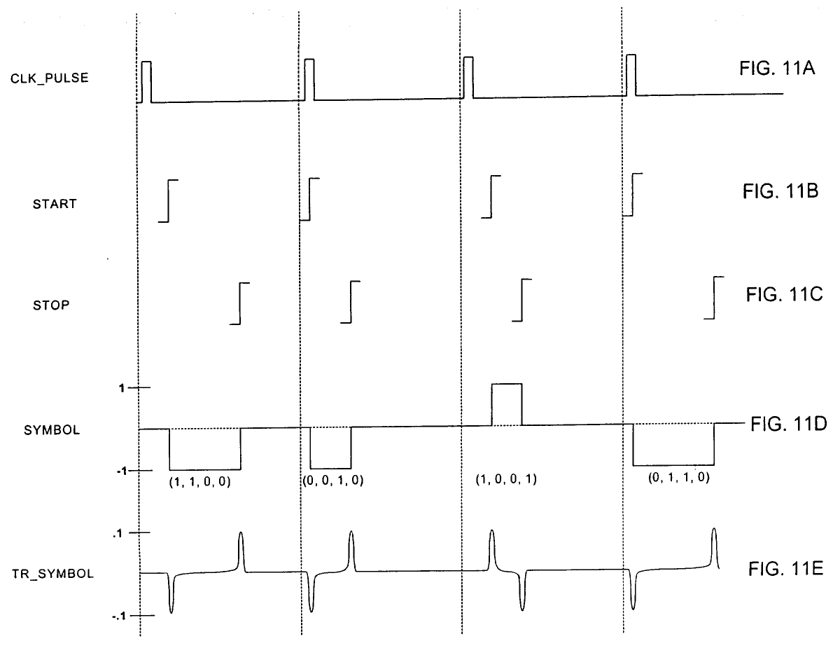

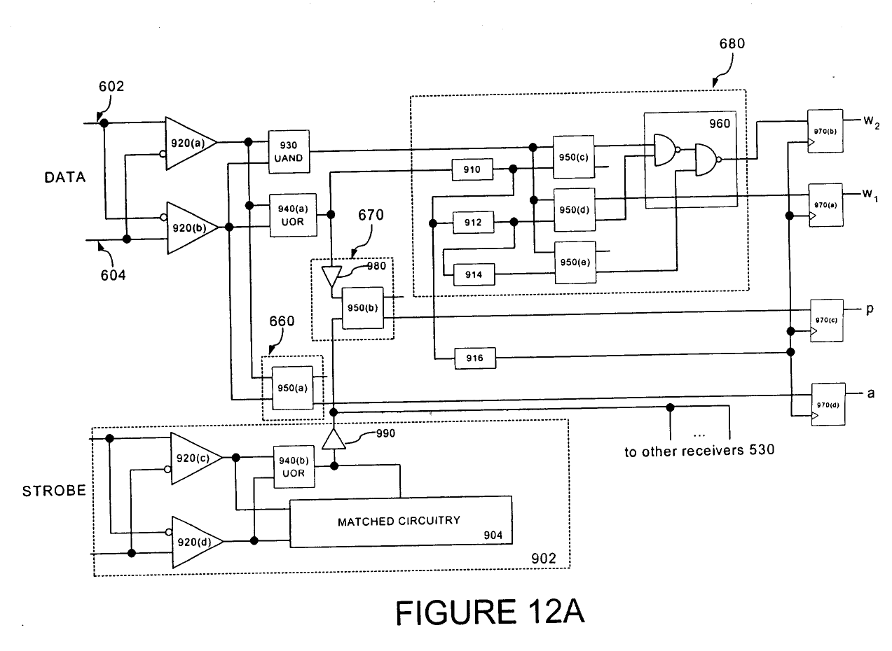

FIG. 11A-11E show CLK_PULSE, START, STOP, SYMBOL, and TR_SYMBOL, respectively, for an embodiment of system 200. Here, TR_SYMBOL represents the form of SYMBOL following transmission across electromagnetic coupler 240. The smaller amplitude of TR_SYMBOL relative to SYMBOL is roughly indicated by the scale change between the waveforms of FIG. 11D and 11E. TR_SYMBOL represents the signal that is decoded by interface 230 to extract data bits for further processing by device 220. The four outbound bits encoded by each SYMBOL are indicated below the corresponding SYMBOL in the order (p₁, w₁, w₂, a)

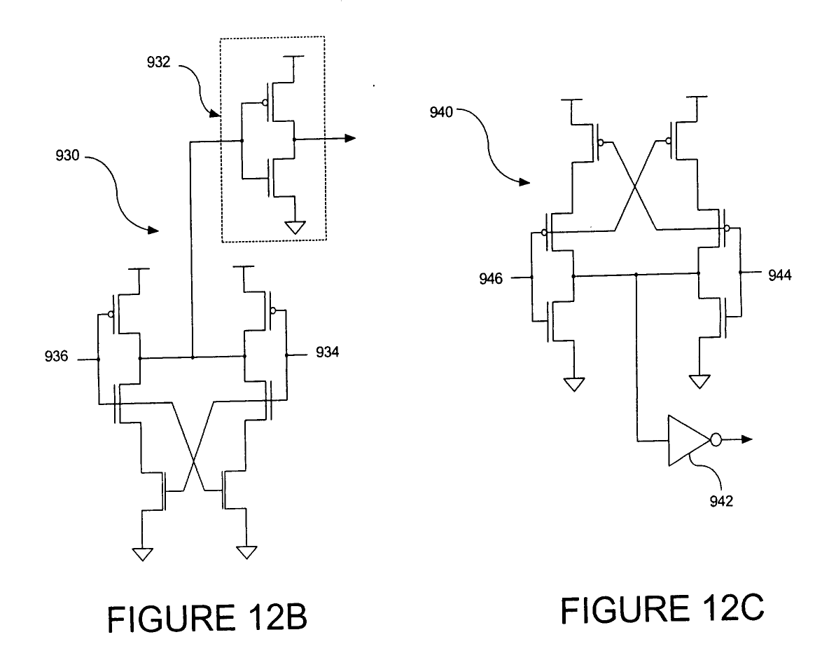

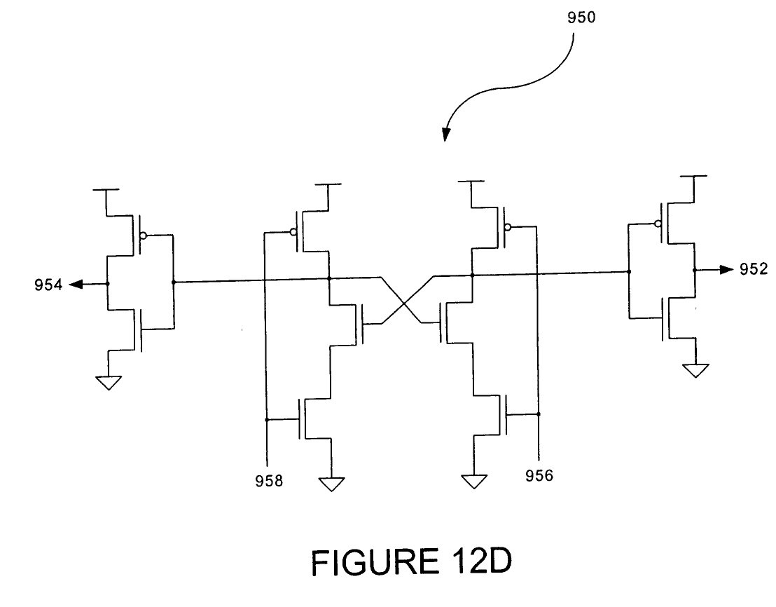

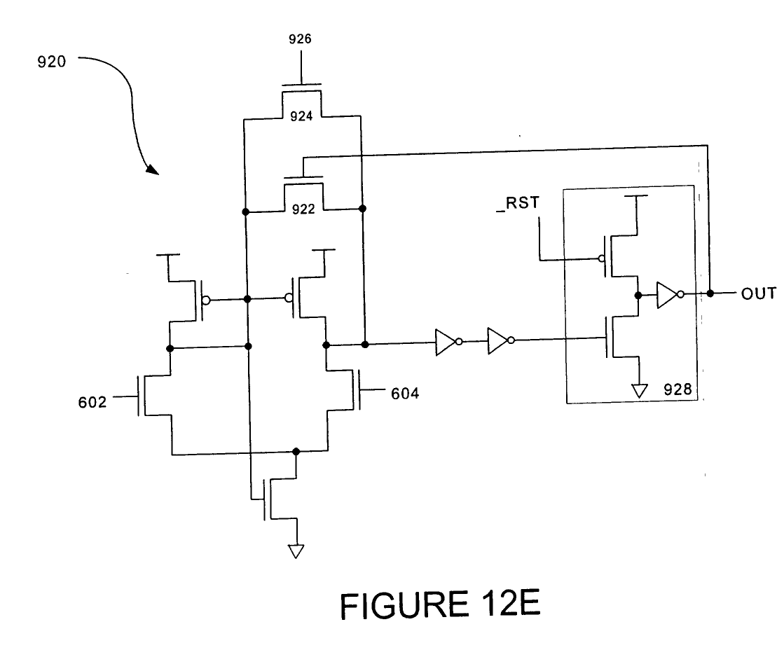

FIG. 12A is a schematic diagram of an example receiver 530. The example receiver 530 processes differential data signals. FIG. 12A also shows a strobe receiver 902, which is suitable for processing a differential strobe signal. Strobe receiver 902 may provide delay matching for receiver 530 similar to that discussed above. Receiver 530 and strobe receiver 902 may be used, for example, in system 200 in conjunction with the embodiments of transmitter 540 and strobe transmitter 790 discussed above.

The example receiver 530 includes differential to single-ended amplifiers 920(a) and 920(b) which compensate for the energy attenuation associated with electromagnetic coupler 240. Amplifiers 920(a) and 920(b) produce digital pulses in response to either positive or negative pulses on the transferred signal (TR_SYMBOL in FIG. 11E) and its complement, e.g. the signals at inputs 602 and 604. In addition to amplification, amplifiers 920 may latch their outputs with appropriate timing signals to provide sufficient pulse widths for succeeding digital circuits.

Matching strobe receiver 902 similarly amplifies the accompanying differential strobe signal. In this example, the received strobe is used to decode phase information in data symbol 420. Strobe receiver 902 includes differential to single-ended amplifiers 920(c) and 920(d) and matched circuitry 904. Matched circuitry 904 replicates much of the remaining circuitry in receiver 530 to match delays for data and strobe signals, similar to the matching of transmitter 540 and strobe transmitter 790. An example strobe receiver 902 includes circuits that correspond to phase demodulator 670 and width demodulator 680 with some minor modifications. For example, strobe buffer 990 buffers the received strobe for distribution to multiple receivers 530, up to the number of channels in, e.g., bus 210. Strobe buffer 990 may be large, depending on the number of receivers it drives. Data buffer 980 corresponds to strobe buffer 990. To save area, data buffer 980 need not be an exact replica of strobe buffer 990. The delays can also be matched by scaling down both data buffer 980 and its loading proportionately, relative to their counterparts in strobe receiver 902.

Uni-OR gate (UOR) 940(a) combines the outputs of amplifiers 920(a) and 920(b) to recover the first edge of TR_SYMBOL. The name uni-OR indicates that the propagation delay through gate 940 is uniform with respect to the two inputs. An embodiment of UOR 940 is shown in FIG. 12C. Similarly, uni-AND gate (UAND) 930 recovers the second edge of TR_SYMBOL. An embodiment of UAND 930 is shown in FIG. 12B.

The example phase demodulator 670 includes an arbiter 950(b) (generically, “arbiter 950”) and data buffer 980. Arbiter 950(b) compares the first edge recovered from the transferred symbol by UOR 940(a) with the corresponding edge from the recovered strobe by UOR 940(b), respectively, and sets a phase bit according to whether the recovered first edge of the symbol leads or follows the first edge of the strobe. An embodiment of arbiter 950 is shown in FIG. 12D. An output 952 goes high if input 956 goes high before input 958. Output 954 goes high if input 958 goes high before input

FIG. 12E is a circuit diagram representing an embodiment of amplifier 920. The example amplifier 920 includes a reset equalization device 922, a gain control device 924, and a pre-charged latch 928. Reset device 922 speeds up the resetting of amplifier 920 after a detected pulse, in preparation for the next symbol period. Gain control device 924 compensates the gain of amplifier 920 for variations in process, voltage, temperature, and the like. A control signal 926 may be provided by calibration circuit 520. More generally, device 924 may be multiple devices connected in series or parallel, and signal 926 may be several signals (analog or digital) produced by calibration circuit 520. Pre-charged latch 928 reshapes received pulses for the convenience of succeeding circuits. Resulting output pulse widths are determined by a timing signal, _RST. For an embodiment of amplifier 920, _RST is produced by DM 916 (FIG. 12A), along with other timing signals used in receiver 530. It is possible for pre-charged latch 928 and signal _RST to be in inconsistent states, due to power-on sequences or noise. Additional circuitry may be used to detect and correct such events.

The example amplitude demodulator 660 includes an arbiter 950(a) which receives the amplified transferred signals from amplifiers 920(a) and 920(h). Arbiter 950(a) sets an amplitude bit according to whether the output of amplifier 920(a) or 920(b) pulses first.

The example width demodulator 680 includes delay modules (DMs) 910, 912, 914, arbiters 950(c), 950(d), 950(e), and decoding logic 960. The recovered first symbol edge is sent through DMs 910, 912, and 914 to generate a series of edge signals having delays that replicate the delays associated with different symbol widths. DMs 910, 912, and 914 may be implemented as programmable delay modules (FIG. 10B). Arbiters 950(c), 950(d), and 950(e) determine the (temporal) position of the second edge with respect to the generated edge signals. Decoding logic 960 maps this position to a pair of width bits.

Latches 970(a), 970(b), 970(c), and 970(d) receive first and second width bits, the phase bit, and the amplitude bit, respectively, at their inputs, and transfer the extracted (inbound) bits to their outputs when clocked by a clocking signal. For the example receiver 530, the latches are clocked by sampling a signal from the delay chain of width demodulator 680 through the extra delay of DM 916. This latching synchronizes the demodulated bits to the accompanying strobe timing. In addition, a device 220 may require a further synchronization of the data to a local clock, e.g. clock synchronization circuit 560 in FIG. 8B.

The various components in an example of interface 230 include a number of circuit elements that may be adjusted to compensate for process, voltage, temperature variations and the like. For example, compensation may entail adjusting the delay provided by a programmable delay module (DM 770), the gain provided by an amplifier (amplifier 920), or the termination resistance (device sets 690(a) and 690(b)).

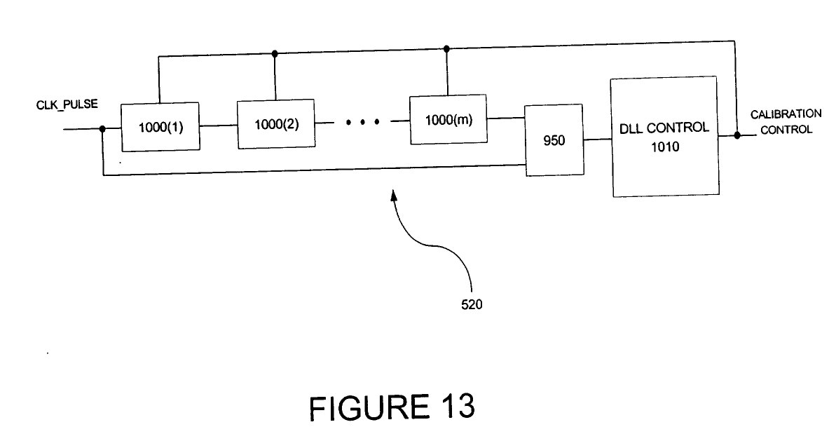

FIG. 13 shows an embodiment of a calibration circuit 520. The purpose of calibration is to use feedback to measure and compensate for variable process, temperature, voltage, and the like. The example calibration circuit 520 shown in FIG. 13 is a delay-locked loop (DLL). A clock signal (CLK_PULSE) is delayed by series-connected DMs 1000(1)-1000(m). The number of DMs is chosen so that the sum of the delays can be set to match one period of CLK_PULSE.

Arbiter 950 is used to detect when the sum of the delays through DMs 1000 is less than, equal to, or more than one clock period. DLL control 1010 cycles through delay control settings until the sum of the delays matches one clock period.

The established control setting reflects the effects of process, temperature, voltage, etc. on the delays of DMs 1000. Calibration circuit 520 may be operated continuously, periodically, when conditions (temperature, voltage, etc.) change, or according to any of a variety of other strategies.

The same calibration control settings can be distributed to DMs used throughout interface 230, such as DM 712, DM 910, etc. The desired delays of DMs in interface 230 are achieved by selecting a number of programmable delay modules 770 for each such DM which have the same ratio to the total number of delay modules 770 included in all the DMs 1000 as the ratio of the desired delay to the clock period. For example, if there are twenty total delay modules 770 in the sum of DMs 1000, one can select a delay of one tenth of the clock period by using two delay modules 770 for any particular DM used in interface 230. In addition, one can also choose a fractional extra delay for any particular DM by inserting small extra loads at the outputs of selected delay modules 770 which constitute that DM.

The calibration information obtained by calibration circuit 520 may also be used to control other circuit parameters in the face of variable conditions. These other parameters may be for uses unrelated to the factor calibrated by the calibration circuit 520 and may include resistance (e.g., the resistance of termination device 690) and gain (e.g., the gain of amplifier 920). This control of other circuit parameters may be done by correlating (leveraging) the information contained in the delay control setting with the effects of process, temperature, voltage, and like conditions on the other circuit parameters.

Other embodiments are within the scope of the following claims.

What is claimed is:

1. A method comprising:
enabling a modulation scheme that conveys at least two bits of information using differential voltages having variable common mode voltage and using two voltage references; and
rejecting the common mode voltage.

2. The method of claim 1 in which the common mode voltage has a non-zero value.

3. The method of claim 1 further comprising enabling an orthogonal modulation scheme in addition to the modulation scheme.

4. The method of claim 3 in which the orthogonal modulation scheme includes a width modulation scheme.

5. The method of claim 3 in which the orthogonal modulation scheme includes a rise-time modulation scheme.

6. The method of claim 1 in which the modulation scheme uses an additional voltage reference.

7. The method of claim 1 in which the differential voltages include a voltage pair in which one of the voltage pair voltages equals zero.

8. The method of claim 1 further comprising enabling the information to be used in an electromagnetically coupled multi-drop bus environment.

9. An article comprising:
a machine-readable medium which contains machine-executable instructions, the instructions causing a machine to:
enable a modulation scheme that conveys at least two bits of information using differential voltages having variable common mode voltage and using two voltage references;
reject the common mode voltage.

10. The article of claim 9 in which the common mode voltage has a non-zero value.

11. The article of claim 9 further causing a machine to enable an orthogonal modulation scheme in addition to the modulation scheme.

12. The article of claim 11 in which the orthogonal modulation scheme includes a width modulation scheme.

13. The article of claim 11 in which the orthogonal modulation scheme includes a rise-time modulation scheme.

14. The article of claim 11 in which the modulation scheme uses an additional voltage reference.

15. The article of claim 11 in which the differential voltages include a voltage pair in which one of the voltage pair voltages equals zero.

16. The article of claim 11 further causing a machine to enable the information to be used in an electromagnetically coupled multi-drop bus environment.

17. An apparatus comprising:
a transmitter configured to transmit differential voltages having variable common mode voltage;
a voltage generation mechanism configured to provide two voltage references to the transmitter; and
a receiver configured to receive the differential voltages and to perform a demodulation scheme that conveys at least two bits of information using the differential voltages.

18. The apparatus of claim 17 in which the transmitter is also configured to receive the voltage references from a source outside the apparatus.

19. The apparatus of claim 17 further comprising
an electromagnetically coupled bus, and
a zig-zag coupler associated with the electromagnetically coupled bus and configured to stabilize coupling coefficients associated with the differential voltages using a zig-zag coupler shape for transferring the differential voltages.

20. The apparatus of claim 17 further comprising
an electromagnetically coupled bus, and
a coupler associated with the electromagnetically coupled bus and configured to reduce translation of common mode noise to differential noise.

21. The apparatus of claim 17 in which the receiver is also configured to use a common mode rejection technique.

22. A system comprising:
a bus;
a device;
an interface configured to use two voltage references to encode at least two bits to symbols for transmission from the bus to the device and to decode symbols to at least two bits for transmission to the bus from the device, the symbols including differential voltages having variable common mode voltage.

23. The system of claim 22 in which the bus includes a multi-drop bus.

24. The system of claim 22 in which the interface includes an electromagnetic coupler.

25. The system of claim 22 in which the interface is also configured to reject the common mode voltage.

26. A method comprising:
providing a first voltage at a first voltage level;
providing a second voltage at a second voltage level different from the first voltage level, the first voltage level and the second voltage level having a variable common mode voltage;
coding at least two bits of data using two voltage references and using a difference between the first voltage level and the second voltage level; and
rejecting the common mode voltage.

27. The method of claim 26 further comprising
providing a third voltage at a third voltage level,
providing a fourth voltage at a fourth voltage level different from the third voltage level, the third voltage level and the fourth voltage level having a variable common mode voltage, and
coding the data also using a difference between the third voltage level and the fourth voltage level.

28. The method of claim 26 further comprising
providing at least one additional pair of voltages, each pair including two voltages at different voltage levels and having a variable common mode voltage, and
coding the data also using differences between the voltage levels of each of the pairs.

29. The method of claim 26 further comprising transmitting the data between a device and an electromagnetically coupled bus.
